(19) United States
(12) Patent Application Publication
(10) Pub. No.: US 2018/0218594 A1
(43) Pub. Date: Aug. 2, 2018

(54) DEPTH CONTROL FOR HOME APPLIANCES

(71) Applicant: MEDIATEK INC., Hsin-Chu (TW)

(72) Inventors: Chih-Kai CHANG, Taichung City (TW); Shuo-Li SHIH, New Taipei City (TW); Chun-Chia CHEN, Hsinchu City (TW); Tsu-Ming LIU, Hsinchu City (TW)

(21) Appl. No.: 15/418,876

(22) Filed: Jan. 30, 2017

(51) Int. Cl. G08C 17/02; G08C 23/04

(52) U.S. Cl. CPC G08C 17/02; G08C 23/04; G08C 2201/70; G08C 2201/32; G08C 2201/93; G08C 2201/92

(57) ABSTRACT

A depth-control method for home appliances in an indoor space and an associated electronic system are provided. The method includes the steps of: connecting the home appliances to a portable electronic device via one or more wireless channels; obtaining identity information for the home appliances using the portable electronic device via the one or more wireless channels; detecting sensor data associated with the portable electronic device; selecting one among a first set of the home appliances according to the sensor data; and controlling the selected home appliance using the portable electronic device.

### BACKGROUND OF THE INVENTION

### Field of the Invention

The invention relates to electronic systems, and, in particular, to a depth-control method for home appliances in an indoor space and associated electronic system.

### Description of the Related Art

With advances in technology, wearable devices such as smart watches, smart bracelets, and fitness bands have become more and more popular. With the help of a smart wearable device supporting various wireless protocols such as infrared ray (IR), Wifi, Bluetooth, etc., a user may use his or her hand to intuitively and naturally interact with home appliances within an indoor space. For example, the user may use his or her smart wearable device to turn power to home appliances on and off, switch channels on a smart TV, change the sound volume on a speaker, activate a washlet, etc.

However, home appliances can be arranged in different locations in the indoor space. When the user uses his or her smart wearable device to aim in the direction (e.g. a line of sight) of a certain home appliance, there might be several other home appliances having a remote control function that lie along the line of the direction aimed at. Thus, it is difficult for the user to select a home appliance to be controlled using his or her smart wearable device.

Accordingly, there is demand for a control method for home appliances in an indoor space and an associated electronic system to solve the aforementioned problem.

### BRIEF SUMMARY OF THE INVENTION

A detailed description is given in the following embodiments with reference to the accompanying drawings.

In an exemplary embodiment, a depth-control method for home appliances in an indoor space is provided. The method includes the steps of: connecting the home appliances to a portable electronic device via one or more wireless channels; obtaining identity information of the home appliances using the portable electronic device via the one or more wireless channels; detecting sensor data associated with the portable electronic device; selecting one among a first set of the home appliances according to the sensor data; and controlling the selected home appliance using the portable electronic device.

In another exemplary embodiment, an electronic system is provided. The electronic system includes a portable electronic device and a plurality of home appliances. The home appliances are connected to the portable electronic device via one or more wireless channels. The portable electronic device further selects one among a first set of the home appliances according to sensor data associated with the portable electronic device, and controls the selected home appliance.

### BRIEF DESCRIPTION OF THE DRAWINGS

The invention can be more fully understood by reading the subsequent detailed description and examples with references made to the accompanying drawings, wherein:

FIG. 1 is a block diagram of an electronic system in accordance with an embodiment of the invention;

FIG. 2 is a diagram of the floor plan of the indoor space in accordance with an embodiment of the invention;

FIG. 3 is a schematic block diagram of the portable electronic device in accordance with an embodiment of the invention; and

FIG. 4 is a flow chart of a depth-control method for home appliances in accordance with an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

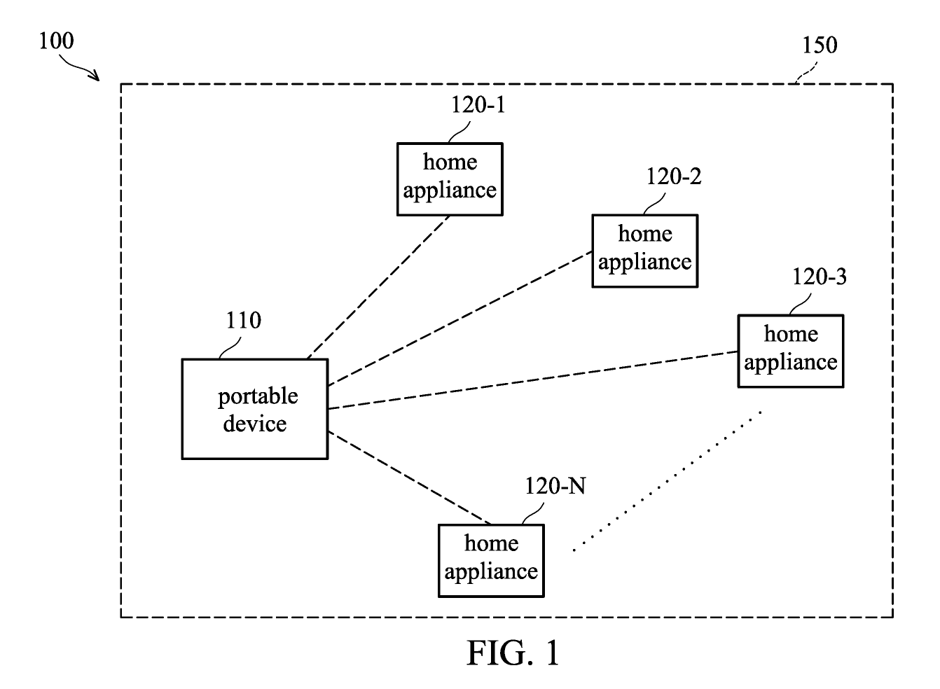

FIG. 1 is a block diagram of an electronic system in accordance with an embodiment of the invention. The electronic system 100 includes a portable electronic device 110, and a plurality of home appliances 120-1˜120-N. The home appliances 120-1˜120-N can be disposed in different locations or partitions in an indoor space 150. For example, a smart TV and a speaker can be disposed in a living room. A washlet can be disposed in the restroom. A smart bulb can be disposed on the ceiling or in a desk lamp. Another portable electronic device such as a tablet PC can be disposed anywhere in the indoor space.

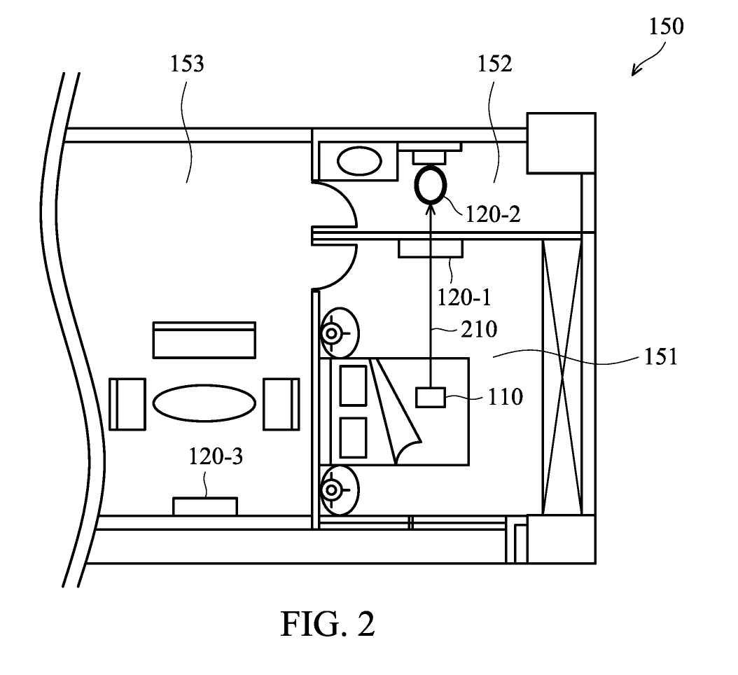

Each of the home appliances 120-1˜120-N supports one or more wireless communication protocols such as IR, Bluetooth, Wifi, etc, and is connected to the portable electronic device 110 via one of the above-mentioned wireless communication protocols. Specifically, the portable electronic device 110 may obtain pre-defined location information for each home appliance in the indoor space 150 upon establishing a connection between the portable electronic device 110 and the home appliance. FIG. 2 is a diagram of the floor plan of the indoor space in accordance with an embodiment of the invention. Referring to FIG. 1 and FIG. 2, in an embodiment, the home appliances 120-1˜120-N are arranged in different partitions of the indoor space 150. For example, the home appliance 120-1, e.g. a speaker, is deployed on the wall of a bedroom 151, and the home appliance 120-2, e.g. a washlet, is deployed in a restroom 152, and the home appliance 120-3, e.g. a smart TV, is deployed in a living room 153. When the user is located in the bedroom and uses his or her portable electronic device 110 to aim in a specific direction (i.e. arrow 210), the portable electronic device 110 may recognize that the home appliances 120-1 and 120-2 overlap on the aimed line according to the floor plan of the home appliances in the indoor space 150. Then, the user may use his or her portable electronic device 110 to determine which one of the home appliances on the line is to be controlled by performing a specific operation depending on which sensor mode is being activated. Notably, the user is capable of controlling the home appliance 120-2 even if the home appliance 120-2 is behind the wall of the bedroom 151 and is not visible to the user in the embodiment.

For example, there are one or more sensors deployed in the portable electronic device 110, and there are various sensor modes for performing the specific operation for determining which home appliance is to be controlled among the home appliances that overlap on the line. For example, the portable electronic device 110 may comprise at least one of an accelerometer, a magnetometer, a gyroscope, a proximity sensor, an action-potential sensor, etc. In an embodiment, the aforementioned sensors can be integrated into a sensor hub of the portable electronic device 110. Accordingly, the user may utilize the portable electronic device 110 to perform the corresponding specific operation according to the sensor being activated.

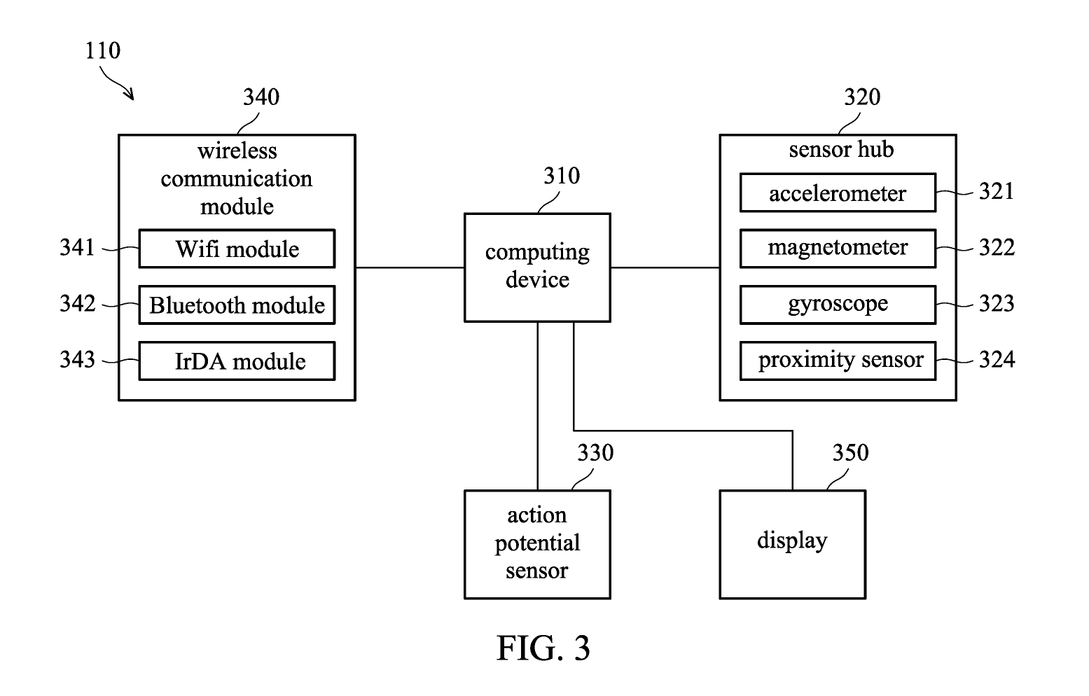

FIG. 3 is a schematic block diagram of the portable electronic device in accordance with an embodiment of the invention. In an embodiment, the portable electronic device 110 includes a computing device 310, a sensor hub 320, an action-potential sensor 330, a wireless communication module 340, and a display 350. The computing device 310, for example, may be a general-purpose processor, an application-specific processor, a digital signal processor, an integrated circuit, a system-on-chip (SoC), or any other equivalent circuitry capable of performing the depth-control method for home appliances in the application. The sensor hub 320 may include one or more sensors such as an accelerometer 321, a magnetometer 322, a gyroscope 323, a proximity sensor 324, etc. The action-potential sensor 330 may be an electromyography (EMG) sensor that allows the portable electronic device 110 to measure the electrical activity of the muscles of the user. In some embodiments, the action-potential sensor 330 can be integrated into the sensor hub 320.

The wireless communication module 340 may include at least one of a Wifi module 341, a Bluetooth module 342, and an infrared ray data associated (IrDA) module 343 that provide a wireless connection between the portable electronic device 110 and each home appliance. Each home appliance in the indoor space 150 is equipped with at least one wireless transceiver, and so each home appliance may connect to one of the Wifi module 341, the Bluetooth module 342, and the IrDA module 343 depending on the wireless communication protocol supported by each home appliance.

In an embodiment, the portable electronic device 110 and the home appliances may connect to a wireless access point (AP) via the Wifi protocol, and the portable electronic device 110 may obtain the IP address of each home appliance as identity information through the wireless AP. When the user utilizes the portable electronic device 110 to perform a specific operation to select one of the home appliances that overlap on the aimed line, the portable electronic device may send commands to the selected home appliance through the wireless AP. In an alternative embodiment, the Wifi module 341 of the portable electronic device 110 may act as a hotspot or a wireless access point, so that the home appliances may directly connect to the portable electronic device through the Wifi module 341.

In an embodiment, when the portable electronic device 110 serves as a Bluetooth host via the Bluetooth module 342, the home appliances may directly connect to the portable electronic device 110 via the Bluetooth or Bluetooth Low Energy (BLE) protocol as Bluetooth clients, and each home appliance may have an individual address and name as its unique identity information. Accordingly, the portable electronic device 110 may obtain the identity information from each home appliance via the Bluetooth module 342 after the Bluetooth connection between the portable electronic device 110 and each home appliance has been established. Accordingly, after the specific operation has been performed for selecting one of the home appliances, the portable electronic device 110 may send commands directly to the selected Bluetooth client via the Bluetooth module 342.

In an embodiment, since the portable electronic device 110 may identify different IR codes via the IrDA module 343, the portable electronic device 110 may obtain a respective unique IR code emitted from each home appliance via the IrDA module 343. Accordingly, after the specific operation has been performed for selecting one of the home appliances, the portable electronic device 110 may directly send commands to the selected home appliance via the IrDA module 343.

It should be noted that one or more wireless communication protocols can be simultaneously used by the portable electronic device 110 to obtain identity information for the home appliances.

In an embodiment, the computing device 310 may render a user interface showing the valid home appliances in the indoor space. Specifically, the valid home appliances indicate the home appliances that have successfully built connections with the portable electronic device 110. In some embodiments, the icons of the valid home appliances are rendered on the display 350, so that the user may see which home appliance is currently being selected on the aimed line. In some other embodiments, the computing device 310 may analyze the home-appliance-usage history and determine the most frequently used home appliances. Then, the icons of the most frequently used home appliances can be rendered on the display 350.

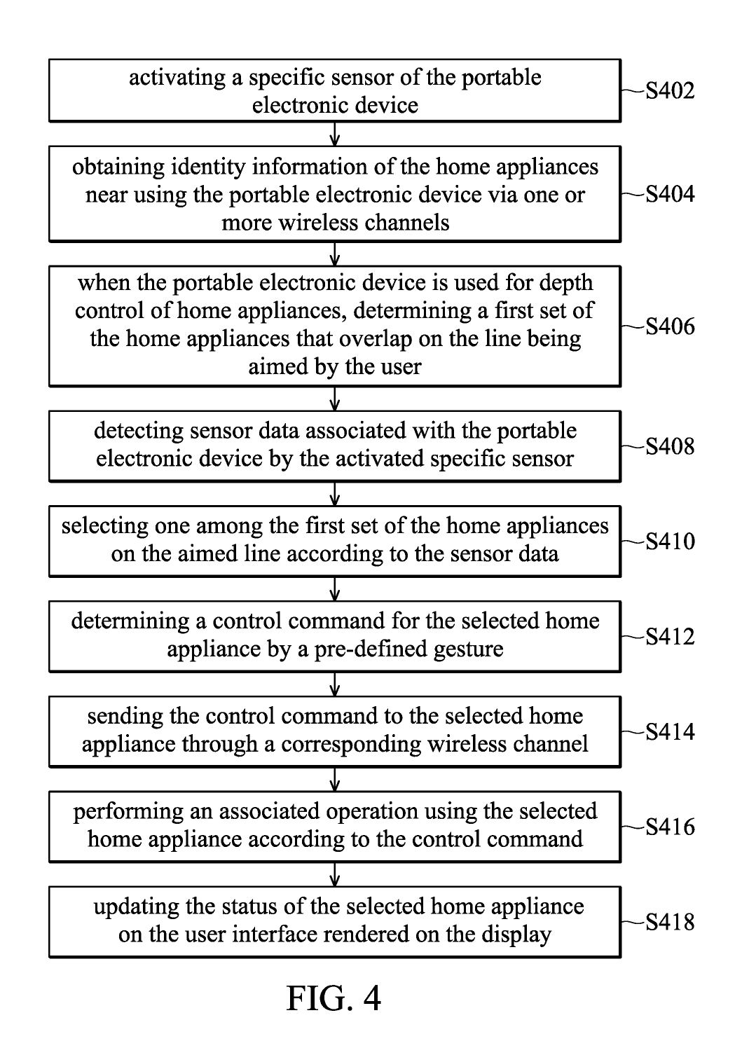

FIG. 4 is a flow chart of a depth-control method for home appliances in accordance with an embodiment of the invention. In step S402, a specific sensor of the portable electronic device 110 is activated. For example, the specific sensor may be one of the sensors in the sensor hub 320, such as an accelerometer, a magnetometer, a gyroscope, a proximity sensor, or an action-potential sensor. In some embodiments, step S402 can be omitted.

In step S404, the portable electronic device 110 obtains the identity information of the home appliances nearby via one or more wireless channels. For example, the obtained identity information may include the pre-defined indoor location of each home appliance.

In step S406, when the portable electronic device 110 is used for depth control of home appliances, the portable electronic device 110 determines which home appliances are overlapping on the line being aimed by the user.

In step S408, the activated specific sensor detects sensor data associated with the portable electronic device.

For example, when the activated sensor is an accelerometer, the sensor data may indicate the direction of the user's gesture. If the user's hand is moving fast in the aimed direction, the next home appliance farther away from the portable electronic device 110 on the aimed line will be selected. Conversely, if the user's hand is moving fast toward the user's body, the next home appliance closer to the portable electronic device 110 will be selected.

In another example, when the activated sensor is a magnetometer, the sensor data may indicate the cardinal direction of the gesture. Specifically, the portable electronic device 110 may act as a compass that is placed horizontally, and the user may rotate the compass to different points of the compass to select the home appliance on the aimed line.

In yet another example, when the activated sensor is a gyroscope, the predetermined sensor data may indicate the rotation angle of the user's arm that holds the portable electronic device 110. Accordingly, the portable electronic device 110 may determine which home appliance is currently being selected according to the rotation angle.

In yet another example, when the activated sensor is a proximity sensor, the sensor data may indicate the distance between the portable electronic device 110 and the user's arm or hand that holds the portable electronic device 110. Accordingly, the portable electronic device 110 may determine which home appliance is currently being selected according to the distance between the portable electronic device 110 and the arm or hand.

In yet another example, when the activated sensor is an action-potential sensor, the sensor data may indicate the electromyography generated from the muscle contractions involved in arm waving. For example, a specific electromyography may indicate to select a home appliance farther down the aimed line, and another specific electromyography may indicate to select a home appliance closer on the aimed line. Accordingly, the portable electronic device 110 may determine which home appliance is currently being selected according to the electromyography.

In some embodiments, each home appliance may be equipped with an indicator light such as a light-emitting diode. When the user selects one of the home appliances on the aimed line via one of the aforementioned methods utilizing different sensors, the indicator light of the currently selected home appliance is turned on and the indicator lights of other home appliances are turned off. When the user selects the home appliance from near to far one by one, the indicator light of the selected home appliance is also turned on sequentially.

Attention now is directed back to FIG. 4. In step S410, one of the home appliances is selected according to the sensor data detected by the activated specific sensor.

In step S412, the status and the icon of the selected home appliance is rendered (or highlighted) on the display 350. In some embodiments, step S412 can be omitted.

In step S412, the control command for the selected home appliance is determined by a pre-defined gesture. For example, the pre-defined gesture may have a different motion type compared with the sensor data detected by the currently activated sensor for selecting one of the home appliances. If the currently activated sensor is an accelerometer, the rotation angle could be the pre-defined gesture for controlling the selected home appliance. For example, when a speaker is currently selected, the user may rotate the portable electronic device 110 clockwise to increase the volume of the speaker, and rotate the portable electronic device 110 counterclockwise to decrease the volume of the speaker. One having ordinary skill in the art will appreciate that appropriate gestures can be designed for different home appliances.

In step S414, the control command is sent to the selected home appliance through a corresponding wireless channel. It should be noted that the home appliances may connect to the portable electronic device 110 through different wireless protocols, and thus the control command that is sent to the selected home appliance should be transmitted through the corresponding wireless channel of the selected home appliance.

In step S416, the selected home appliance performs an associated operation according to the control command, and reports its status back to the portable electronic device 110 through the corresponding wireless channel.

In step S418, the status of the selected home appliance is updated on the user interface rendered on the display 350 of the portable electronic device 110.

In view of the above, a depth-control method for home appliances and an associated electronic system are provided. With the help of the depth-control method, the user may easily select one of the home appliances from among those that are overlapping on the same line being aimed at, and control the selected home appliance using the portable electronic device.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

1. A control method for home appliances in an indoor space, comprising:
connecting the home appliances to a portable electronic device via one or more wireless channels;
obtaining identity information of the home appliances using the portable electronic device via the one or more wireless channels;
detecting sensor data associated with the portable electronic device;
selecting one among a first set of the home appliances according to the sensor data;
controlling the selected home appliance utilizing the portable electronic device; and
determining the first set of the home appliances that overlap on a line of sight of the user when the portable electronic device applies depth control on the home appliances.

2. (canceled)

3. The method as claimed in claim 1, wherein the one or more wireless channels support Wifi, Bluetooth, and/or infrared ray data associated (IrDA) protocols.

4. The method as claimed in claim 1, wherein the specific sensor is an accelerometer, and the detected sensor data indicate motion and acceleration of the portable electronic device.

5. The method as claimed in claim 1, wherein the specific sensor is a magnetometer, and the detected sensor data indicate a direction of the portable electronic device as a compass.

6. The method as claimed in claim 1, wherein the specific sensor is a gyroscope, and the detected sensor data indicate a rotation angle of the portable electronic device.

7. The method as claimed in claim 1, wherein the specific sensor is a proximity sensor, and the detected sensor data indicate a distance between the portable electronic device and an arm of a user that holds the portable electronic device.

8. The method as claimed in claim 1, wherein the specific sensor is an action-potential sensor, and the detected sensor data indicate an electromyography of muscle contraction of an arm of the user that holds the portable electronic device.

9. The method as claimed in claim 1, wherein each of the home appliances comprises an indicator light, and the indicator light of the selected home appliance is turned on while the indicator lights of other unselected home appliances are turned off.

10. The method as claimed in claim 1, wherein the step of controlling the selected home appliance with the portable electronic device comprises:
generating a control command according to a pre-defined gesture;
transmitting the control command through the wireless channel corresponding to the selected home appliance; and
controlling the selected home appliance to perform a specific operation indicated by the control command.

11. An electronic system, comprising:
a portable electronic device; and
a plurality of home appliances, connected to the portable electronic device via one or more wireless channels,
wherein the portable electronic device obtains identity information of the home appliances via the one or more wireless channels,
wherein the portable electronic device selects one of a first set of the home appliances according to sensor data associated with the portable electronic device, and controls the selected home appliance,
wherein when the portable electronic device applies depth control on the home appliances, the portable electronic device determines the first set of the home appliances that overlap on a line of sight of the user.

12. The electronic system as claimed in claim 11, wherein the one or more wireless channels support Wifi, Bluetooth, and/or infrared ray data associated (IrDA) protocols.

13. The electronic system as claimed in claim 11, wherein the specific sensor is an accelerometer, and the detected sensor data indicate motion and acceleration of the portable electronic device.

14. The electronic system as claimed in claim 11, wherein the specific sensor is a magnetometer, and the detected sensor data indicate a cardinal direction of the portable electronic device.

15. The electronic system as claimed in claim 11, wherein the specific sensor is a gyroscope, and the detected sensor data indicate a rotation angle of the portable electronic device.

16. The electronic system as claimed in claim 11, wherein the specific sensor is a proximity sensor, and the detected sensor data indicate a distance between the portable electronic device and an arm of a user that holds the portable electronic device.

17. The electronic system as claimed in claim 11, wherein the specific sensor is an action-potential sensor, and the detected sensor data indicate an electromyography of muscle contraction of an arm of the user that holds the portable electronic device.

18. The electronic system as claimed in claim 11, wherein each of the home appliances comprises an indicator light, and the indicator light of the selected home appliance is turned on while the indicator lights of other unselected home appliances are turned off.

19. The electronic system as claimed in claim 11, wherein the portable electronic device further generates a control command according to a pre-defined gesture, transmits the control command through the wireless channel corresponding to the selected home appliance, and controls the selected home appliance to perform a specific operation indicated by the control command.

20. (canceled)
